(19) United States
(12) Patent Application Publication
(10) Pub. No.: US 2003/0150359 A1
(43) Pub. Date: Aug. 14, 2003

(54) Coating powders containing effects pigments and coating powder dispersions (powder slurries)

(76) Inventor: Walter Lassmann, (US)

Correspondence Address: BASF CORPORATION, ANNE GERRY SABOURIN, 26701 TELEGRAPH ROAD, SOUTHFIELD, MI, 48034-2442, US

(21) Appl. No.: 10/276,004

(22) PCT Filed: Jun. 1, 2001
(86) PCT No.: PCT/EP01/06227

(30) Foreign Application Priority Data
Jun. 2, 2000 (DE) 10027295.9

(51) Int. Cl. C09C 1/62; C08K 5/00

(52) U.S. Cl. 106/499; 106/403; 106/404

(57) ABSTRACT

A powder coating material or powder coating dispersion (powder slurry) comprising at least one hydrophilic effect pigment, and the use thereof.

The present invention relates to novel powder coating materials and powder coating dispersions (powder slurries) which comprise effect pigments. The present invention further relates to the use of the novel powder coating materials and powder slurries in automotive finishing, in the interior and exterior coating of constructions, in the coating of furniture, doors and windows, and in industrial coating, including coil coating and container coating.

Color and/or effect coating systems on motor vehicle bodies, especially automobile bodies, nowadays consist preferably of a number of coats which are applied over one another and have different properties.

For example, an electrodeposition coat (EDC) as primer, a surfacer coat or antistonechip primer, a basecoat, and a clearcoat are applied in succession to a substrate. In this system, the EDC serves in particular to protect the metal panel against corrosion. In the art it is often also referred to as the primer. The surfacer coat serves to cover unevennesses in the substrate and because of its elasticity impart stonechip resistance. If appropriate, the surfacer coat may also serve to reinforce the hiding power and to deepen the shade of the coating system. The basecoat contributes the colors and/or the optical effects. The clearcoat is used to intensify the optical effects and to protect the coating system against mechanical and chemical damage. Basecoat and clearcoat are often also referred to collectively as topcoat. For further details, reference is made to Römpp Lexikon Lacke und Druckfarben, Georg Thieme Verlag, Stuttgart, New York, 1998, pages 49 and 51, “Automotive finishes”.

In modern-day automotive finishing, therefore, an important objective is to reduce significantly, or even to zero, the amount of organic solvents emitted in the coating operation. Appropriate coating materials, such as EDCs, aqueous surfacers or aqueous clearcoats, powder coating materials or powder slurry clearcoats, are available. A continuing disadvantage, however, is that for the basecoats it is still necessary to use nonaqueous, i.e., conventional, basecoats or aqueous basecoats containing a comparatively high proportion of organic solvents in order to disperse the pigments stably and to ensure effective leveling of the applied coats.

Furthermore, to use the coating materials, especially the basecoats and clearcoats, conjointly to produce a color and/or effect coating system requires that their properties be matched to one another with great precision in order to avoid, for example, the breakdown of the uncured coats when employing wet-on-wet techniques and/or to prevent cracking, popping, and/or coat delamination.

It would therefore be desirable to replace the customary and known basecoats, including aqueous basecoats, by solvent-free powder coating materials and powder slurries which comprise effect pigments (cf. Römpp Lexikon Lacke und Druckfarben, Georg Thieme Verlag, 1998, page 176, “Effect pigments” and pages 380 and 381, “Metal oxide-mica pigments” to “Metal pigments”). Initial approaches have already been taken.

For example, Coatings Partner, the magazine of BASF, Powder Coatings Special, 1/2000, pages 4 to 6, or the BASF Coatings AG brochure “Pulverlacke, Pulverlacke für industrielle Anwendungen” [Powder coating materials, powder coatings for industrial applications], January 2000, disclose pigmented powder coating materials which are also suitable as basecoats.

Furthermore, Japanese Patent Application JP 53 109 540 A1 (Derwent Abstract 78800A/44) discloses a coating system comprising a basecoat which is from 10 to 45 μm thick and is prepared from a pigmented powder slurry, of which no further details are given, and a clearcoat which is from 30 to 70 μm thick.

German Laid-Open Specification DE 27 10 421 A1 discloses a powder slurry which comprises metal-effect pigments and is based on amine-neutralized acrylate copolymers and melamine resins or on polyesters and epoxy resins. The preparation of the pigmented powder slurries, however, requires that the water-soluble amine-neutralized starting materials be neutralized with hydrochloric acid. This may, however, permanently damage the metal-effect pigments. The known powder slurry gives smooth, glossy, metallic coatings. It is unknown whether this slurry is suitable for producing multicoat effect coating systems.

Japanese Patent Application JP 02 014 776 A2 discloses a multicoat system, comprising basecoat and clearcoat, whose basecoat is prepared from a pigmented powder slurry based on hydroxyl-containing acrylate copolymers and blocked polyisocyanates.

U.S. Pat. No. 5,379,947 A1 discloses cosolvent-free pigmented and unpigmented powder slurries based, for example, on hydroxyl-containing acrylate copolymers and blocked polyisocyanates or glycidyl-containing acrylate copolymers and dodecanedioic acid.

Furthermore, U.S. Pat. No. 4,268,542 A1 discloses comparable powder slurries and powder coating materials comprising effect pigments.

The known pigmented powder coating materials and powder slurries, however, have metallic effects and/or optical effects which are unable to meet the heightened requirements of automotive OEM finishing, especially in the top-class segment, and for this reason powder coating materials and powder slurries have not yet become established as basecoats. Furthermore, the known powder slurries, pigmented with aluminum effect pigments, have a tendency toward decomposition and evolution of hydrogen on prolonged storage, especially under conditions of elevated temperature.

It is an object of the present invention to provide new powder coating materials and powder slurries, comprising effect pigments, which no longer have the disadvantages of the prior art but instead, when used as basecoats, provide multicoat effect coating systems with metallic effects and/or dichroic effects that satisfy even the heightened requirements of the automakers and the customers in the top-class segment. Furthermore, the new powder slurries should no longer exhibit any decomposition or evolution of hydrogen on storage.

Accordingly we have found the novel powder coating materials and powder coating dispersions (powder slurries) comprising at least one hydrophilic effect pigment which, in the text below, are referred to as “powder coating materials and powder slurries of the invention”.

Further subjects of the invention will emerge from the description.

In the light of the prior art it was surprising and unforeseeable for the skilled worker that the powder slurries and powder coating materials of the invention would permit the production of multicoat effect coating systems which satisfy even heightened requirements of the market, a surprise being the particularly uniform distribution of the effect pigments within the matrix of the coating system. A further surprise was that the powder slurries of the invention no longer show decomposition or evolution of hydrogen of the metal effect pigments present herein.

Even more surprising was that the powder slurries of the invention permit the production of what are known as combination effect coats, which in multicoat effect coating systems possess the functions both of surfacer coats and antistonechip primers and of basecoats. This is all the more surprising since, firstly, the powder slurries are always proposed for the production of coats having essentially only one function, and, secondly, the customary and known surfacer coats and basecoats are produced from coating materials which are materially very different and have been very specifically adapted to their respective end use.

In the context of the present invention, the term “multicoat effect coating system” comprises both achromatic (cf. Römpp Lexikon Lacke und Druckfarben, Georg Thieme Verlag, 1998, page 590, “Achromatic point”) and chromatic, i.e., colored, multicoat systems.

The powder slurry of the invention comprises at least one finely divided dimensionally stable constituent, i.e., a powder coating material of the invention, as disperse phase and an aqueous medium as continuous phase.

The finely divided dimensionally stable constituent or powder coating material of the invention can be solid and/or of high viscosity. In the context of the present invention, “of high viscosity” means that the particles behave essentially like solid particles under the customary and known conditions of the preparation, storage, and use of powder slurries or powder coating materials. Preferably, the powder coating material is solid.

The individual particles of the finely divided constituent or powder coating material are, moreover, dimensionally stable. In the context of the present invention, “dimensionally stable” means that, under the customary and known conditions of the storage and use of powder slurries and powder coating materials, the particles agglomerate only slightly if at all and/or break down into smaller particles only slightly if at all, instead essentially retaining their original form even under the effect of shear forces.

Preferably, the solids content of the powder slurry of the invention is from 10 to 80, more preferably from 15 to 75, with particular preference from 20 to 70, with very particular preference from 25 to 70, and, in particular, from 30 to 65% by weight, based in each case on the powder slurry of the invention.

In the case of the powder coating material of the invention, the solids content is of course 100% by weight.

Preferably, the average particle size of the finely divided dimensionally stable constituents of the powder slurry of the invention is from 0.8 to 40 μm, more preferably from 0.8 to 20 μm, and with particular preference from 2 to 6 μm. The average particle size is the 50% median determined by the laser diffraction method, i.e., 50% of the particles have a diameter≦the median and 50% of the particles have a diameter≧the median. Generally, the particle size of said constituents reaches its upper limit when the size of the particles means that they are no longer able to flow completely on baking, and the film leveling is adversely affected as a result. 40 μm is considered a reasonable upper limit, since above this particle size blockage of the rinsing ducts of the highly sensitive application apparatus may be expected.

Pigmented powder slurries comprising average particle sizes of this kind exhibit better application properties and surprisingly, at the applied film thicknesses of >30 μm as currently practiced in the automotive industry for the OEM finishing of automobiles, exhibit a markedly smaller tendency toward popping and “mudcracking” than conventional combinations of surfacer, basecoat and clearcoat.

The particle size distribution of the powder coating materials of the invention may vary comparatively widely and is guided by the respective intended use. Preferably, the particle size distribution is comparatively narrow, with a very small coarse fraction (particle sizes above 95 μm) and fine fraction (particles sizes below 5.0 μm). Particular preference is given to using powder coating materials having the particle size distribution described in European Patent Application EP 0 666 779 A1.

Surprisingly, the powder coating materials of the invention exhibit essentially the same advantages as set out above for the powder slurries of the invention.

The powder slurry of the invention and the powder coating material of the invention are preferably free from organic solvents (cosolvents). For the purposes of the present invention this means that they have a residual volatile solvent content of <2.0% by weight, preferably <1.5% by weight, and with particular preference <1.0% by weight. In accordance with the invention, it is especially advantageous if the residual content is below the gas chromatography detection limit.

The constituent of the powder coating materials and powder slurries of the invention that is essential to the invention is at least one hydrophilic effect pigment.

Regarding the term “effect pigments”, reference is made to Römpp Lexikon Lacke und Druckfarben, Georg Thieme Verlag, 1998, page 176, “Effect pigments”, and pages 380 and 381, “Metal oxide-mica pigments” to “Metal pigments”. Accordingly, suitable effect pigments are metal flake pigments such as commercial aluminum bronzes, aluminum bronzes chromated in accordance with DE-A-36 36 183, commercial stainless steel bronzes, and metal and nonmetal effect pigments, such as pearlescent pigments and interference pigments, for example. Particular preference is given to using metal effect pigments, especially aluminum effect pigments.

In the context of the present invention, hydrophilicity is the constitutional property of a molecule or functional group to penetrate the aqueous phase or to remain therein. Accordingly, in the context of the present invention, hydrophobicity is the constitutional property of a molecule or a functional group to behave exophilically with respect to water, i.e., they display the tendency not to penetrate into water, or to leave the aqueous phase. For further details, reference is made to Römpp Lexikon Lacke und Druckfarben, Georg Thieme Verlag, Stuttgart, New York, 1998, “Hydrophilicity” “Hyphobicity”, pages 294 and 295.

For the hydrophilicization of the effect pigments for use in accordance with the invention, all conceivable methods may be considered, such as, for instance, the preparation of effect pigments whose surface is hydrophilic as a result of the chemical composition of the effect pigment per se or of the topmost layer of the effect pigment, or the use of surface reactions which generate hydrophilic functional groups on the surface, such as acidic or basic groups.

In accordance with the invention, however, it is of advantage to coat the surface of the effect pigments with surface-active substances. This has the key advantage that it is possible to refrain from laborious synthesis processes or subsequent chemical modification, which always carries with it the risk of altering the essential performance properties of the effect pigments. Moreover, it has the key advantage that it can be done with a minimum of additives, since in many cases just a monolayer of the surface-active substances is sufficient to achieve the desired effect. In many cases, this monolayer need not even fully cover the surface of the effect pigment; rather, partial coverage is adequate.

The amount of surface-active substances for hydrophilicizing the effect pigments may, consequently, vary greatly from case to case. Preferably, amounts of less than 1% by weight are used, in particular less than 0.5% by weight, based in each case on the amount of the effect pigment and of the surface-active substance.

Preferably, after coating with the surface-active substances, the hydrophilic effect pigment still has a powder-form consistency.

In the context of the present invention, a surface-active substance is a compound which, dissolved or dispersed in a liquid, are preferentially absorbed on a surface and so reduce the surface tension (cf. Römpp Lexikon Lacke und Druckfarben, Georg Thieme Verlag, 1998, page 271, “Surface-active substances”, “Surface activity”, and “Surface tension”.

Particularly suitable surface-active substances are surfactants, since they do not react with the effect pigments and/or cause their agglomeration, have no interfering inherent color, are optically transparent, induce no shift in shade, and/or do not enter into any disruptive physical and/or chemical interactions with the other constituents of the powder coating materials and powder slurries of the invention, such as the formation of salts or adducts, for instance. The skilled worker will therefore be able to select the appropriate surfactants on the basis of his or her general technical knowledge, possibly with the aid of simple rangefinding experiment.

Especially suitable surfactants are nonionic surfactants.

In accordance with the invention, suitable nonionic surfactants (cf. Römpp Lexikon Lacke und Druckfarben, Georg Thieme Verlag, 1998, page 410, “Nonionic surfactants”) are surfactants whose hydrophilicity is established by means of polyether chains, hydroxyl groups, carboxamido groups and/or ester groups, but especially polyether chains. Examples of highly suitable nonionic surfactants are adducts of ethylene oxide and/or propylene oxide with fatty alcohols, alkylphenols, fatty acids, lower alcohols or glycols (polyalkylene glycols), of which the polyalkylene glycols are particularly advantageous and are therefore used with preference in accordance with the invention.

Examples of highly suitable polyalkylene glycols are polyethylene glycols, polypropylene glycols, block copolymers of ethylene oxide and propylene oxide (Pluronics®) or polytetramethylene glycols (polytetrahydrofurans) (cf. Römpp Lexikon Lacke und Druckfarben, Georg Thieme Verlag, 1998, page 457, “Polyalkylene glycols”), of which the polypropylene glycols are particularly advantageous and are therefore used with particular preference in accordance with the invention.

Especially suitable polypropylene glycols have a number-average molecular weight of from 350 to 1000, preferably from 400 to 950, with particular preference from 450 to 900, with very particular preference from 500 to 850, and in particular from 550 to 800 daltons.

The polypropylene glycols are commercial products and are marketed, for example, by the company BASF Aktiengesellschaft under the brand name Pluriol® 400, 600 or 900, the suffixed numbers indicating the molecular weight or its magnitude.

The hydrophilic effect pigments may have a comparatively narrow particle size distribution. In this case the average particle size—as defined below—is preferably from 5 to 20 and in particular from 10 to 11 μm, the maximum particle size generally not exceeding 30, and in particular 25, μm.

Alternatively, the hydrophilic effect pigments may have a comparatively broad particle size distribution. This means that the hydrophilicized effect pigment in question has a comparatively large fine fraction, i.e., pigment particles of a size in the range from 1 to 10 μm, and a comparatively large coarse fraction, with a particle size in the range from 70 to 90 μm. This results in a particularly flat slope of the cumulative particle distribution curve. Preferably, the minimum particle size is 1.0, more preferably 3.0, with particular preference 5.0, with very particular preference 8.0, and in particular 10 μm. The maximum particle size is preferably 90, more preferably 80, with particular preference 70, with very particular preference 60, and in particular 50 μm. The average particle size, as defined below, is preferably from 20 to 60, more preferably from 22 to 58, with particular preference from 24 to 56, with very particular preference from 26 to 54, and in particular from 28 to 52 μm.

The method of preparing the hydrophilic effect pigments used with preference in accordance with the invention has no special features but instead takes place by applying the surfactants, especially the nonionic surfactants, to the effect pigments in suitable mixing equipment for powders, which permit gentle coating of the effect pigments, such as fluidized bed apparatus or mills. If necessary, coating is followed by drying, further grinding and/or sieving of the hydrophilic effect pigments.

In a first embodiment which is preferred in accordance with the invention, the finely divided dimensionally stable constituents of the powder clearcoats and powder slurries of the invention comprise the totality of the hydrophilic effect pigments used.

In a second embodiment which is preferred in accordance with the invention, the finely divided dimensionally stable constituents of the powder clearcoats and powder slurries of the invention contain no hydrophilic effect pigments; i.e., all of the hydrophilic effect pigments used are present in the form of a separate solid phase. For their particle size, the comments made above apply analogously.

In a third embodiment which is preferred in accordance with the invention, the finely divided dimensionally stable constituents of the powder clearcoats and powder slurries of the invention comprise one portion of the hydrophilic effect pigments used, with the other portion being present in the form of a separate solid phase. In this case, the fraction present in the finely divided dimensionally stable constituents may comprise the majority, i.e., more than 50%, of the hydrophilic effect pigments used. However, it is also possible for less than 50% to be located within the finely divided dimensionally stable constituents. With regard to the particle sizes, the comments made above also apply analogously here.

The particular variant of the powder clearcoats and powder slurries of the invention that is given preference depends in particular on the nature of the hydrophilic effect pigments and/or on the process by which the powder clearcoats and powder slurries of the invention that are used in each case are prepared. In many cases, the second preferred embodiment offers particular advantages, and so is particularly preferred in accordance with the invention, in particular in the case of powder slurries.

The proportion of the hydrophilic effect pigments for use in accordance with the invention in the powder clearcoats and powder slurries of the invention may vary very widely and is guided by the requirements of the specific case, in particular by the optical effect to be established and/or by the hiding power of the particular hydrophilic effect pigments used. Preferably, the coated effect pigment content is from 1.0 to 20, more preferably from 0.3 to 18, with particular preference from 0.5 to 16, with very particular preference from 0.7 to 14, and, in particular, from 0.9 to 12% by weight, based in each case on the powder coating material of the invention or on the solids of the powder slurry of the invention.

In addition to the hydrophilic effect pigments for use in accordance with the invention, the powder clearcoats and powder slurries of the invention may comprise further, customary and known color and/or effect pigments.

These pigments may comprise organic or inorganic compounds. Because of this large number of suitable pigments, therefore, the powder coating materials and powder slurries of the invention ensure universality in their breadth of use and enable the realization of a large number of particularly attractive color shades and optical effects.

Examples of suitable effect pigments are the substrates of the hydrophilic effect pigments to be used according to the invention.

Examples of suitable inorganic color pigments are titanium dioxide, iron oxides, and carbon black. Examples of suitable organic color pigments are thioindigo pigments, indanthrene blue, Irgalith blue, Heliogen blue, Irgazine blue, Palomar blue, Cromophthal red, Hostaperm pink, Irgazine orange, Sicotrans yellow, Sicotan yellow, Hostaperm yellow, Paliotan yellow, and Heliogen green.

For further details reference is made to Römpp Lexikon Lacke und Druckfarben, Georg Thieme Verlag, 1998, pages 180 and 181, “Iron blue pigments” to “Black iron oxide”, pages 451 to 453, “Pigments” to “Pigment volume concentration”, page 563, “Thioindigo pigments”, and page 567, “Titanium dioxide pigments”.

As described above for the hydrophilic effect pigments, the pigments may be present within and outside the finely divided dimensionally stable constituents of the powder coating materials and powder slurries of the invention. With regard to the particle sizes, the comments made above apply analogously here.

The powder coating materials and powder slurries of the invention may further comprise organic and inorganic fillers, which like the pigments may be present within and outside the finely divided dimensionally stable constituents; the comments made with regard to the pigments apply analogously here.

Examples of suitable organic and inorganic fillers are chalk, calcium sulfates, barium sulfate, silicates such as talc or kaolin, silicas, oxides such as aluminum hydroxide or magnesium hydroxide, or organic fillers such as textile fibers, cellulose fibers, polyethylene fibers, polyacrylonitrile powders, polyamide powders, or wood flour. For further details reference is made to Römpp Lexikon Lacke und Druckfarben, Georg Thieme Verlag, 1998, pages 250 ff., “Fillers”. Further examples of suitable fillers are disclosed in German Patent Application DE 196 06 706 A1, column 8, lines 30 to 64. They are preferably used in the amounts specified there.

The pigments and fillers may also be present in an ultrafine, nonhiding form.

The proportion of the pigments, fillers, and hydrophilic effect pigments for use in accordance with the invention in the powder coating materials and powder slurries of the invention may vary very widely and is guided by the requirements of the specific case, in particular by the optical effect to be established and/or by the hiding power of the particular pigments used. Preferably, the pigment, filler and effect pigment content is from 1.0 to 80, more preferably from 2.0 to 75, with particular preference from 3.0 to 70, with very particular preference from 4.0 to 65, and, in particular, from 5.0 to 60% by weight, based in each case on the powder coating material of the inventinon or on the solids of the powder slurry of the invention.

In addition to or instead of the pigments and/or fillers described above, the powder coating materials and powder slurries of the invention may comprise organic dyes in molecularly disperse distribution.

These dyes in molecularly disperse distribution are present in the finely divided dimensionally stable constituents of the powder coating materials of the invention.

In the powder slurries of the invention they may be present either in the dispersed finely divided dimensionally stable constituents or in the continuous phase of the powder slurries of the invention.

Alternatively, they may be present in the dispersed finely divided dimensionally stable constituents and in the continuous phase. In this case, the fraction present in the finely divided dimensionally stable constituents may comprise the majority, i.e., more than 50%, of the organic dyes used. However, it is also possible for less than 50% to be present therein. The distribution of the organic dyes between the phases may correspond to the thermodynamic equilibrium that results from the solubility of the organic dyes in the phases. The distribution may, however, also be far removed from the thermodynamic equilibrium.

Suitable organic dyes are all those which are soluble in the sense described above in the powder coating materials and powder slurries of the invention. Lightfast organic dyes are highly suitable. Particularly suitable lightfast organic dyes are those having little or no tendency to migrate. The migration tendency can be estimated by the skilled worker on the basis of his or her general knowledge in the art and/or determined with the aid of simple preliminary rangefinding tests: for example, in tinting experiments.

The amount of the organic dyes in molecularly disperse distribution in the powder coating materials and powder slurries of the invention may vary extremely widely and is guided primarily by the color and by the shade to be established and also by the amount of any pigments and/or fillers present.

The powder coating materials and powder slurries of the invention may be curable physically or thermally and/or with actinic radiation. The thermally curable powder coating materials and powder slurries, in turn, may be self-crosslinking or externally crosslinking.

In the context of the present invention, the term “physical curing” denotes the curing of a layer of a coating material by filming through loss of solvent from the coating material, with linking within the coating taking place by looping of the polymer molecules of the binders (regarding the term, cf. Römpp Lexikon Lacke und Druckfarben, Georg Thieme Verlag, Stuttgart, New York, 1998, “Binders”, pages 73 and 74). Alternatively, filming takes place by coalescence of binder particles (cf. Römpp Lexikon Lacke und Druckfarben, Georg Thieme Verlag, Stuttgart, New York, 1998, “Curing”, pages 274 and 275). Normally, no crosslinking agents are necessary for this purpose. If desired, physical curing may be assisted by atmospheric oxygen, by heat, or by exposure to actinic radiation.

For the purposes of the present invention, “self-crosslinking” denotes the property of a binder to enter into crosslinking reactions with itself. A prerequisite for this is that the binders already contain both types of complementary reactive functional groups that are necessary for crosslinking. Externally crosslinking, on the other hand, is the term used to refer to coating materials, adhesives and sealing compounds in which one type of the complementary reactive functional groups is present in the binder and the other type in a hardener, curing agent or crosslinking agent. For further details reference is made to Römpp Lexikon Lacke und Druckfarben, Georg Thieme Verlag, Stuttgart, New York, 1998, “Curing”, pages 274 to 276, especially page 275, bottom.

For the purposes of the present invention, actinic radiation is electromagnetic radiation, such as near infrared (NIR), visible light, UV radiation or X-rays, especially UV radiation, and corpuscular radiation such as electron beams.

If thermal and actinic light curing are used together for a powder coating material, the terms used include “dual cure” and “dual-cure powder coating material” or “dual-cure powder slurry”.

The powder coating materials and powder slurries of the invention comprise at least one binder.

The binders are oligomeric and polymeric resins.

In accordance with the invention it is of advantage if the minimum film-forming temperature of the binders is at least 0° C., preferably at least 10, with particular preference at least 15, with very particular preference at least 20, and, in particular, at least 25° C. The minimum film-forming temperature can be determined by drawing down an aqueous dispersion of the binder onto a glass plate using a coating bar or applying a finely divided binder powder to a glass plate and heating it in a gradient oven. The temperature at which the pulverulent layer films is referred to as the minimum film-forming temperature. For further details reference is made to Römpp Lexikon Lacke und Druckfarben, Georg Thieme Verlag, Stuttgart, New York, 1998 “Minimum film-forming temperature”, page 391.

Examples of suitable binders are random, alternating and/or block addition (co)polymers of linear and/or branched and/or comblike construction of ethylenically unsaturated monomers, or polyaddition resins and/or polycondensation resins. For further details of these terms reference is made to Römpp Lexikon Lacke und Druckfarben, Georg Thieme Verlag, Stuttgart, New York, 1998, page 457, “Polyaddition” and “Polyaddition resins (polyadducts)”, and pages 463 and 464, “Polycondensates”, “Polycondensation” and “Polycondensation resins”, and also pages 73 and 74, “Binders”.

Examples of suitable addition (co)polymers are (meth)acrylate (co)polymers or partially hydrolyzed polyvinyl esters, especially (meth)acrylate copolymers.

Examples of suitable polyaddition resins and/or polycondensation resins are polyesters, alkyds, poly-urethanes, polylactones, polycarbonates, polyethers, epoxy resin-amine adducts, polyureas, polyamides, polyimides, polyester-polyurethanes, polyether-poly-urethanes or polyester-polyether-polyurethanes, especially polyester-polyurethanes.

Of these binders, the (meth)acrylate (co)polymers have particular advantages and are therefore used particularly preferably.

The self-crosslinking binders of the thermally curable powder coating materials and powder slurries and of the dual-cure powder coating materials and powder slurries of the invention comprise reactive functional groups which are able to enter into crosslinking reactions with groups of their type or with complementary reactive functional groups. The externally crosslinking binders comprise reactive functional groups which are able to enter into crosslinking reactions with complementary reactive functional groups present in crosslinking agents. Examples of suitable complementary reactive functional groups for use in accordance with the invention are summarized in the following overview. In the overview, the variable R is an acyclic or cyclic aliphatic, an aromatic, and/or an aromatic-aliphatic (araliphatic) radical; the variables R′ and R″ are identical or different aliphatic radicals or are linked to one another to form an aliphatic or heteroaliphatic ring.

Overview: Examples of complementary functional groups

| | | |
|---|---|---|
| Binder | and | crosslinking agent |
| | or | |
| Crosslinking agent | and | binder |

| | |
|---|---|
| —SH | —C(O)—OH |
| —NH₂ | —C(O)—O—C(O)— |
| —OH | —NCO |
| —O—(CO)—NH—(CO)—NH₂ | —NH—C(O)—OR |
| —O—(CO)—NH₂ | —CH₂—OH |
| >NH | —CH₂—O—R |
| | —NH—CH₂—O—R |
| | —NH—CH₂—OH |
| | —N(—CH₂—O—R)₂ |
| | —NH—C(O)—CH(—C(O)OR)₂ |
| | —NH—C(O)—CH(—C(O)OR)(—C(O)—R) |
| | —NH—C(O)—NR′R″ |
| | >Si(OR)₂ |
| | 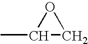 |
| | 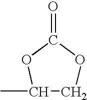 |
| —C(O)—OH | 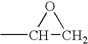 |
| | —N═C═N— |
| | —C(O)—N(CH₂—CH₂—OH)₂ |

The selection of the complementary groups in each case is guided firstly by the fact that during the preparation, storage, application, and melting of the powder coating materials and powder slurries of the invention they should not enter into any unwanted reactions, in particular no premature crosslinking, and/or, if appropriate, should not disrupt or inhibit curing with actinic radiation, and secondly by the temperature range within which crosslinking is to take place.

In the case of the powder coating materials and powder slurries of the invention, it is preferred to employ crosslinking temperatures of from 60 to 180° C. Use is therefore made preferably of thio, hydroxyl, N-methylolamino, N-alkoxymethylamino, imino, carbamate, allophanate and/or carboxyl groups, preferably hydroxyl or carboxyl groups, on the one hand, and preferably crosslinking agents containing anhydride, carboxyl, epoxy, blocked isocyanate, urethane, methylol, methylol ether, siloxane, carbonate, amino, hydroxyl and/or beta-hydroxyalkylamide groups, preferably epoxy, beta-hydroxyalkylamide, blocked isocyanate, urethane or alkoxymethylamino groups, on the other.

In the case of self-crosslinking powder coating materials and powder slurries of the invention, the binders contain in particular methylol, methylol ether, and/or N-alkoxymethylamino groups.

Complementary reactive functional groups especially suitable for use in the powder coating materials and powder slurries of the invention are

carboxyl groups on the one hand and epoxide groups and/or beta-hydroxyalkylamide groups on the other, and

hydroxyl groups on the one hand and blocked isocyanate, urethane or alkoxymethylamino groups on the other.

The functionality of the binders in respect of the reactive functional groups described above may vary very widely and depends in particular on the desired crosslinking density and/or on the functionality of the crosslinking agents employed in each case. In the case of carboxyl-containing binders, for example, the acid number is preferably from 10 to 100, more preferably from 15 to 80, with particular preference from 20 to 75, with very particular preference from 25 to 70, and, in particular, from 30 to 65 mg KOH/g. Alternatively, in the case of hydroxyl-containing binders, the OH number is preferably from 15 to 300, more preferably from 20 to 250, with particular preference from 25 to 200, with very particular preference from 30 to 150, and, in particular from 35 to 120 mg KOH/g. Alternatively, in the case of binders containing epoxide groups, the epoxide equivalent weight is preferably from 400 to 2500, more preferably from 420 to 2200, with particular preference from 430 to 2100, with very particular preference from 440 to 2000, and, in particular, from 440 to 1900.

The complementary functional groups described above can be incorporated into the binders in accordance with the customary and known methods of polymer chemistry. This can be done, for example, by incorporating monomers which carry the corresponding reactive functional groups, and/or with the aid of polymer-analogous reactions.

Examples of suitable olefinically unsaturated monomers containing reactive functional groups are

(a1) monomers which carry at least one hydroxyl, amino, alkoxymethylamino, carbamate, allophanate or imino group per molecule, such as

hydroxyalkyl esters of acrylic acid, methacrylic acid or another alpha,beta-olefinically unsaturated carboxylic acid, which are derived from an alkylene glycol which is esterified with the acid, or which are obtainable by reacting the alpha,beta-olefinically unsaturated carboxylic acid with an alkylene oxide such as ethylene oxide or propylene oxide, especially hydroxyalkyl esters of acrylic acid, methacrylic acid, ethacrylic acid, crotonic acid, maleic acid, fumaric acid or itaconic acid, in which the hydroxyalkyl group contains up to 20 carbon atoms, such as 2-hydroxyethyl, 2-hydroxypropyl, 3-hydroxy-propyl, 3-hydroxybutyl, 4-hydroxybutyl acrylate, methacrylate, ethacrylate, crotonate, maleate, fumarate or itaconate; or hydroxy-cycloalkyl esters such as 1,4-bis(hydroxy-methyl)cyclohexane, octahydro-4,7-methano-1H-indenedimethanol or methylpropanediol mono-acrylate, monomethacrylate, monoethacrylate, monocrotonate, monomaleate, monofumarate or monoitaconate; reaction products of cyclic esters, such as epsilon-caprolactone and these hydroxyalkyl or hydroxycycloalkyl esters;

olefinically unsaturated alcohols such as allyl alcohol;

polyols such as trimethylolpropane monoallyl or diallyl ether or pentaerythritol monoallyl, diallyl or triallyl ether;

reaction products of acrylic acid and/or methacrylic acid with the glycidyl ester of an alpha-branched monocarboxylic acid having 5 to 18 carbon atoms per molecule, especially a Versatic® acid, or instead of the reaction product an equivalent amount of acrylic and/or methacrylic acid, which is then reacted during or after the polymerization reaction with the glycidyl ester of an alpha-branched monocarboxylic acid having 5 to 18 carbon atoms per molecule, especially a Versatic® acid;

aminoethyl acrylate, aminoethyl methacrylate, allylamine or N-methyliminoethyl acrylate;

N,N-di(methoxymethyl)aminoethyl acrylate or methacrylate or N,N-di(butoxymethyl)aminopropyl acrylate or methacrylate;

(meth)acrylamides such as (meth)acrylamide, N-methyl-, N-methylol-, N,N-dimethylol-, N-methoxymethyl-, N,N-di(methoxymethyl)-, N-ethoxymethyl- and/or N,N-di(ethoxyethyl)-(meth)acrylamide;

acryloyloxy- or methacryloyloxyethyl, propyl or -butyl carbamate or allophanate; further examples of suitable monomers containing carbamate groups are described in the U.S. Pat. Nos. 3,479,328, 3,674,838, 4,126,747, 4,279,833 or 4,340,497;

(a2) monomers which carry at least one acid group per molecule, such as

acrylic acid, methacrylic acid, ethacrylic acid, crotonic acid, maleic acid, fumaric acid or itaconic acid;

olefinically unsaturated sulfonic or phosphonic acids or their partial esters;

mono(meth)acryloyloxyethyl maleate, succinate or phthalate; or

vinylbenzoic acid (all isomers), alpha-methylvinylbenzoic acid (all isomers) or vinylbenzenesulfonic acid (all isomers);

(a3) monomers containing epoxide groups, such as the glycidyl ester of acrylic acid, methacrylic acid, ethacrylic acid, crotonic acid, maleic acid, fumaric acid or itaconic acid, or allyl glycidyl ether.

They are preferably used to prepare (meth)acrylate copolymers, especially ones containing glycidyl groups.

More highly functional monomers of the type described above are generally used in minor amounts. For the purposes of the present invention, minor amounts of higher-functional monomers are those amounts which do not lead to crosslinking or gelling of the addition copolymers, in particular of the (meth)acrylate copolymers, unless the specific desire is to prepare crosslinked polymeric microparticles.

Examples of suitable monomer units for introducing reactive functional groups into polyesters or polyester-polyurethanes are 2,2-dimethylolethyl- or -propylamine blocked with a ketone, the resulting ketoxime group being hydrolyzed again following incorporation; or compounds containing two hydroxyl groups or two primary and/or secondary amino groups and also at least one acid group, in particular at least one carboxyl group and/or at least one sulfonic acid group, such as dihydroxypropionic acid, dihydroxy-succinic acid, dihydroxybenzoic acid, 2,2-dimethylolacetic acid, 2,2-dimethylolpropionic acid, 2,2-dimethylolbutyric acid, 2,2-dimethylolpentanoic acid, α,δ-diaminovaleric acid, 3,4-diaminobenzoic acid, 2,4-diaminotoluenesulfonic acid or 2,4-diaminodiphenyl ether sulfonic acid.

One example of introducing reactive functional groups by way of polymer-analogous reactions is the reaction of hydroxyl-containing resins with phosgene, resulting in resins containing chloroformate groups, and the polymer-analogous reaction of the chloroformate-functional resins with ammonia and/or primary and/or secondary amines to give resins containing carbamate groups. Further examples of suitable methods of this kind are known from the U.S. Pat. Nos. 4,758,632 A1, 4,301,257 A1 or 2,979,514 A1.

The binders of the dual-cure powder coating materials and powder slurries of the invention further comprise on average at least one, preferably at least two, group(s) having at least one bond per molecule that can be activated with actinic radiation.

For the purposes of the present invention, a bond that can be activated with actinic radiation is a bond which on exposure to actinic radiation becomes reactive and, with other activated bonds of its kind, enters into addition polymerization reactions and/or crosslinking reactions which proceed in accordance with free-radical and/or ionic mechanisms. Examples of suitable bonds are carbon-hydrogen single bonds or carbon-carbon, carbon-oxygen, carbon-nitrogen, carbon-phosphorus or carbon-silicon single bonds or double bonds. Of these, the carbon-carbon double bonds are particularly advantageous and are therefore used with very particular preference in accordance with the invention. For the sake of brevity, they are referred to below as double bonds.

Accordingly, the group which is preferred in accordance with the invention comprises one double bond or two, three or four double bonds. If more than one double bond is used, the double bonds can be conjugated. In accordance with the invention, however, it is of advantage if the double bonds are present in isolation, in particular each being present terminally, in the group in question. It is of particular advantage in accordance with the invention to use two double bonds or, in particular, one double bond.

The dual-cure binder contains on average at least one of the above-described groups that can be activated with actinic radiation. This means that the functionality of the binder in this respect is integral, i.e., for example, is two, three, four, five or more, or nonintegral, i.e., for example, is from 2.1 to 10.5 or more. The functionality chosen depends on the requirements imposed on the respective pigmented dual-cure powder slurry.

If more than one group that can be activated with actinic radiation is used on average per molecule, the groups are structurally different from one another or of the same structure.

If they are structurally different from one another, this means, in the context of the present invention, that use is made of two, three, four or more, but especially two, groups that can be activated by actinic radiation, these groups deriving from two, three, four or more, but especially two, monomer classes.

Examples of suitable groups are (meth)acrylate, ethacrylate, crotonate, cinnamate, vinyl ether, vinyl ester, dicyclopentadienyl, norbornenyl, isoprenyl, isopropenyl, allyl or butenyl groups; dicyclo-pentadienyl, norbornenyl, isoprenyl, isopropenyl, allyl or butenyl ether groups; or dicyclopentadienyl, norbornenyl, isoprenyl, isopropenyl, allyl or butenyl ester groups, but especially acrylate groups.

Preferably, the groups are attached to the respective parent structures of the binders via urethane, urea, allophanate, ester, ether and/or amide groups, but in particular via ester groups. Normally, this occurs as a result of customary and known polymer-analogous reactions such as, for instance, the reaction of pendant glycidyl groups with the olefinically unsaturated monomers described above that contain an acid group, of pendant hydroxyl groups with the halides of these monomers, of hydroxyl groups with isocyanates containing double bonds such as vinyl isocyanate, methacryloyl isocyanate and/or 1-(1-isocyanato-1-methylethyl)-3-(1-methylethenyl)benzene (TMI® from the company CYTEC), or of isocyanate groups with the above-described hydroxyl-containing monomers.

Alternatively, in the dual-cure powder coating materials, it is possible to employ mixtures of purely thermally curable binders and binders that are curable purely with actinic radiation.

The powder coating materials and powder slurries that are curable purely with actinic radiation comprise preferably binders that are curable purely with actinic radiation, said binders preferably containing only the above-described groups that can be activated with actinic radiation.

The material composition of the binders does not basically have any special features; rather, suitable binders include

all the binders envisaged for use in powder clearcoat slurries curable thermally and/or with actinic radiation that are described in U.S. Pat. Nos. 4,268,542 A1 or 5,379,947 A1 and in patent applications DE 27 10 421 A1, DE 195 40 977 A1, DE 195 18 392 A1, DE 196 17 086 A1, DE 196 13 547 A1, DE 196 18 657 A1, DE 196 52 813 A1, DE 196 17 086 A1, DE 198 14 471 A1, DE 196 13 547 A1, DE 198 41 842 A1 or DE 198 41 408 A1, in German Patent Applications DE 199 08 018.6 or DE 199 08 013.5, unpublished at the priority date of the present specification, or in European Patent EP 0 652 264 A1;

all the binders envisaged for use in dual-cure clearcoats that are described in patent applications DE 198 35 296 A1, DE 197 36 083 A1 or DE 198 41 842 A1; or

all the binders envisaged for use in thermally curable powder clearcoats and described in German Patent Application DE 42 22 194 A1, in the product information bulletin from BASF Lacke+Farben AG, “Pulverlacke”, 1990, or in the BASF Coatings AG brochure “Pulverlacke, Pulverlacke für industrielle Anwendungen”, January 2000.

In this case, for the powder coating materials and powder slurries that are curable thermally or thermally and with actinic radiation, use is made predominantly of (meth)acrylate copolymers.

Examples of suitable (meth)acrylate copolymers are the (meth)acrylate copolymers containing epoxide groups, having an epoxide equivalent weight of preferably from 400 to 2500, more preferably from 420 to 2200, with particular preference from 430 to 2100, with very particular preference from 440 to 2000, and, in particular, from 440 to 1900, a number-average molecular weight (determined by gel permeation chromatography using a polystyrene standard) of preferably from 2000 to 20,000 and in particular from 3000 to 10,000, and a glass transition temperature (T_{g}) of preferably from 30 to 80, more preferably from 40 to 70 and in particular from 40 to 60° C. (measured by means of differential scanning calorimetry (DSC), as suitable in particular for use in thermally curable powder clearcoat slurries (see above) and as described, furthermore, in the patents and patent applications EP 0 299 420 A1, DE 22 14 650 B1, DE 27 49 576 B1, U.S. Pat. Nos. 4,091,048 A1 or 3,781,379 A1.

Suitable additional binders for the dual-cure powder coating materials and powder slurries, or sole binders for the powder coating materials and powder slurries that are curable purely with actinic radiation, are the binders envisaged for use in UV-curable clearcoats and powder clearcoats and described in European Patent Applications EP 0 928 800 A1, 0 636 669 A1, 0 410 242 A1, 0 783 534 A1, 0 650 978 A1, 0 650 979 A1, 0 650 985 A1, 0 540 884 A1, 0 568 967 A1, 0 054 505 A1 or 0 002 866 A1, in German Patent Applications DE 197 09 467 A1, 42 03 278 A1, 33 16 593 A1, 38 36 370 A1, 24 36 186 A1 or 20 03 579 B1, in the international patent applications WO 97/46549 or 99/14254, or in U.S. Pat. Nos. 5,824,373 A1, 4,675,234 A1, 4,634,602 A1, 4,424,252 A1, 4,208,313 A1, 4,163,810 A1, 4,129,488 A1, 4,064,161 A1 or 3,974,303 A1.

The preparation of the binders also has no special features as to its method, but takes place with the aid of the customary and known methods of polymer chemistry, as described in detail, for example, in the patent documents recited above.

Further examples of suitable preparation processes for (meth)acrylate copolymers are described in European Patent Applications or EP 0 767 185 A1, in German Patents DE 22 14 650 B1 or DE 27 49 576 B1, and in U.S. Pat. Nos. 4,091,048 A1, 3,781,379 A1, 5,480,493 A1, 5,475,073 A1 or 5,534,598 A1, or in the standard work Houben-Weyl, Methoden der organischen Chemie, 4^{th} Edition, Volume 14/1, pages 24 to 255, 1961. Suitable reactors for the copolymerization are the customary and known stirred vessels, cascades of stirred vessels, tube reactors, loop reactors or Taylor reactors, as described, for example, in the patents and patent applications DE 1 071 241 B1, EP 0 498 583 A1 or DE 198 28 742 A1 or in the article by K. Kataoka in Chemical Engineering Science, Volume 50, No. 9, 1995, pages 1409 to 1416.

The preparation of polyesters and alkyd resins is also described, for example, in the standard work Ullmanns Encyklopädie der technischen Chemie, 3^{rd} Edition, Volume 14, Urban & Schwarzenberg, Munich, Berlin, 1963, pages 80 to 89 and pages 99 to 105, and also in the following books: “Résines Alkydes-Polyesters” by J. Bourry, Paris, Dunod, 1952, “Alkyd Resins” by C. R. Martens, Reinhold Publishing Corporation, New York, 1961, and “Alkyd Resin Technology” by T. C. Patton, Interscience Publishers, 1962.

The preparation of polyurethanes and/or acrylated polyurethanes is also described, for example, in the patent applications EP 0 708 788 A1, DE 44 01 544 A1 or DE 195 34 361 A1.

The binder content of the powder coating materials of the invention or of the disperse phase of the powder slurries of the invention may vary very widely and depends in particular on whether they are physically or thermally self-crosslinking. In both these cases, it can be preferably from 20 to 99.9, more preferably from 25 to 99.7, with particular preference from 30 to 99.5, with very particular preference from 35 to 99.3, and, in particular, from 40 to 99.1% by weight, based in each case on the solids content of the pigmented powder slurry. In the other cases (curable thermally, or thermally and with actinic radiation), the binder content is preferably from 10 to 80, more preferably from 15 to 75, with particular preference from 20 to 70, with very particular preference from 25 to 65, and, in particular, from 30 to 60% by weight, based in each case on the solids content of the pigmented powder slurry.

The externally crosslinking powder coating materials and powder slurries of the invention curable thermally, or thermally and with actinic radiation, comprise at least one crosslinking agent which comprises the reactive functional groups complementary to the reactive functional groups of the binders. Consequently, the skilled worker is easily able to select the crosslinking agents suitable for a given powder coating material or a given powder slurry.

Examples of suitable crosslinking agents are

amino resins, as described for example in Römpp Lexikon Lacke und Druckfarben, Georg Thieme Verlag, 1998, page 29, “Amino resins”, in the textbook “Lackadditive” [Coatings additives] by Johan Bieleman, Wiley-VCH, Weinheim, New York, 1998, pages 242 ff., in the book “Paints, Coatings and Solvents”, second, completely revised edition, eds. D. Stoye and W. Freitag, Wiley-VCH, Weinheim, New York, 1998, pages 80 ff., in U.S. Pat. No. 4 710 542 A1 or EP 0 245 700 A1, and in the article by B. Singh and coworkers “Carbamyl-methylated Melamines, Novel Crosslinkers for the Coatings Industry” in Advanced Organic Coatings Science and Technology Series, 1991, Volume 13, pages 193 to 207;

carboxyl-containing compounds or resins, as described for example in the patent DE 196 52 813 A1 or 198 41 408 A1, especially dodecanedioic acid;

epoxy-containing compounds or resins, as described for example in patents EP 0 299 420 A1, DE 22 14 650 B1, DE 27 49 576 B1, U.S. Pat. Nos. 4,091,048 A1 or 3,781,379 A1;

blocked polyisocyanates, as described for example in the U.S. Pat. No. 4,444,954 A1, DE 196 17 086 A1, DE 196 31 269 A1, EP 0 004 571 A1 or EP 0 582 051 A1;

beta-hydroxyalkylamides such as N,N,N′,N′-tetrakis(2-hydroxyethyl)adipamide or N,N,N′,N′-tetrakis(2-hydroxypropyl)adipamide; and/or

tris(alkoxycarbonylamino)triazines, as described in U.S. Pat. Nos. 4,939,213 A1, 5,084,541 A1, 5,288,865 A1 or EP 0 604 922 A1.

The crosslinking agent content of the powder coating materials and powder slurries of the invention may likewise vary very widely and depends on the requirements of the individual case, in particular on the number of reactive functional groups present. It is preferably from 1.0 to 40, more preferably from 2.0 to 35, with particular preference from 3.0 to 30, with very particular preference from 4.0 to 27, and, in particular, from 5.0 to 25% by weight, based in each case on the powder coating material of the invention or on the solids content of the powder slurry of the invention.

In addition to the above-described coated effect pigments and binders and, if appropriate, the above-described pigments, fillers, dyes and/or crosslinking agents, the powder coating materials and powder slurries of the invention may further comprise at least one additive. Depending on its physicochemical properties and/or its function, said additive may be present essentially in the solid finely divided constituents of the powder coating materials and powder slurries of the invention or, in the case of the power slurries of the invention, essentially in the continuous phase.

Examples of suitable additives are

thermally curable reactive diluents such as positionally isomeric diethyloctanediols or hydroxyl-containing hyperbranched compounds or dendrimers as described in German Patent Application DE 198 50 243 A1;

reactive diluents curable with actinic radiation, such as those described in Römpp Lexikon Lacke und Druckfarben, Georg Thieme Verlag, Stuttgart, New York, 1998 on page 491 under the headword “Reactive diluents”;

crosslinking catalysts such as dibutyltin dilaurate, lithium decanoate or zinc octoate, amine-blocked organic sulfonic acids, quaternary ammonium compounds, amines, imidazole and imidazole derivatives such as 2-styrylimidazole, 1-benzyl-2-methylimidazole, 2-methylimidazole and 2-butylimidazole, as described in Belgian Patent No. 756,693, or phosphonium catalysts such as ethyltriphenylphosphonium iodide, ethyltriphenyl-phosphonium chloride, ethyltriphenylphosphonium thiocyanate, ethyltriphenylphosphonium acetate-acetic acid complex, tetrabutylphosphonium iodide, tetrabutylphosphonium bromide and tetrabutyl-phosphonium acetate-acetic acid complex, as are described, for example, in U.S. Pat. Nos. 3,477,990 A1 or 3,341,580 A1;

thermally labile free-radical initiators such as organic peroxides, organic azo compounds or C-C-cleaving initiators such as dialkyl peroxides, peroxocarboxylic acids, peroxodicarbonates, peroxide esters, hydroperoxides, ketone peroxides, azodinitriles or benzpinacol silyl ether;

photoinitiators, as described in Römpp Chemie Lexikon, 9^{th} expanded and revised edition, Georg Thieme Verlag, Stuttgart, Vol. 4, 1991, or in Römpp Lexikon Lacke und Druckfarben, Georg Thieme Verlag, Stuttgart, 1998, pages 444 to 446;

antioxidants such as hydrazines and phosphorus compounds;

UV absorbers such as triazines and benzotriphenol;

light stabilizers such as HALS compounds, benzotriazoles or oxalanilides;

leveling agents;

free-radical scavengers and polymerization inhibitors such as organic phosphites or 2,6-di-tert-butylphenol derivatives;

slip additives;

defoamers;

emulsifiers, especially nonionic emulsifiers such as alkoxylated alkanols and polyols, phenols and alkylphenols, or anionic emulsifiers such as alkali metal salts or ammonium salts of alkanecarboxylic acids, alkanesulfonic acids, and sulfo acids of alkoxylated alkanols and polyols, phenols and alkylphenols;

wetting agents such as siloxanes, fluorine compounds, carboxylic monoesters, phosphoric esters, polyacrylic acids and their copolymers, or polyurethanes, as described, for example, in detail in patent application DE 198 35 296 A1, especially in conjunction with the polyurethane-based associative thickeners described below;

adhesion promoters such as tricyclodecanedi-methanol;

film-forming auxiliaries such as cellulose derivatives;

flame retardants;

devolatilizers such as diazadicycloundecane or benzoin;

water retention agents;

free-flow aids;

rheology control additives (thickeners), such as those known from patents WO 94/22968, EP-A-0 276 501, EP-A-0 249 201 or WO 97/12945; crosslinked polymeric microparticles, such as those disclosed, for example, in EP-A-0 008 127; inorganic sheet silicates such as aluminum-magnesium silicates, sodium-magnesium and sodium-magnesium-fluorine-lithium sheet silicates of the montmorillonite type; silicas such as Aerosils; or synthetic polymers having ionic and/or associative groups, such as polyvinyl alcohol, poly(meth)-acrylamide, poly(meth)acrylic acid, polyvinyl-pyrrolidone, styrene-maleic anhydride copolymers or ethylene-maleic anhydride copolymers and their derivatives or polyacrylates; or polyurethane-based associative thickeners, as described in Römpp Lexikon Lacke und Druckfarben, Georg Thieme Verlag, Stuttgart, New York, 1998, “Thickeners”, pages 599 to 600, and in the textbook “Lackadditive” by Johan Bieleman, Wiley-VCH, Weinheim, New York, 1998, pages 51 to 59 and 65; especially combinations of ionic and nonionic thickeners, as described in patent application DE 198 41 842 A1 for establishing a pseudoplastic behavior, or the combination of polyurethane-based associative thickeners and polyurethane-based wetting agents, as is described in detail in German Patent Application DE 198 35 296 A1.

Further examples of suitable additives are described in the textbook “Lackadditive” by Johan Bieleman, Wiley-VCH, Weinheim, New York, 1998. They are employed in the customary and known amounts.

The preparation of the powder coating materials of the invention has no special features as to method but instead takes place as described in the product information bulletin from BASF Lacke+Farben AG, “Pulverlacke”, 1990, or in the BASF Coatings AG brochure “Pulverlacke, Pulverlacke für industrielle Anwendungen”, January 2000, by homogenization and dispersion, using for example an extruder or screw compounder, and milling of the constituents described above. Following preparation of the powder coating materials of the invention, they are prepared for application or dispersing by further milling and, if appropriate, by classifying and sieving to prepare the powder slurries of the invention.

The preparation of the powder slurries of the invention also has no special features as to method but instead takes place in accordance with customary and known processes.

In a first preferred variant, the preparation of the powder slurries of the invention from the constituents described above takes place essentially as described in detail in patent applications DE 195 40 977 A1, DE 195 18 392 A1, DE 196 17 086 A1, DE-A-196 13 547, DE 196 18 657 A1, DE 196 52 813 A1, DE 196 17 086 A1, DE-A-198 14 471 A1, DE 198 41 842 A1 or DE 198 41 408 A1, except that in the context of the present invention effect pigments are processed as well. Here, the powder coating material of the invention is converted to the powder slurry of the invention by wet milling or by stirred incorporation of dry-milled powder coating material into water or an aqueous medium. Particular preference is given to wet milling.

In another preferred variant of preparing the powder slurries of the invention, the constituents described above are emulsified in an organic solvent to give an emulsion of the oil-in-water type, after which the organic solvent is removed; as a result of this, the emulsified droplets solidify to give the powder slurry of the invention. If desired, it may further be subjected to wet milling in order to improve its filterability.

In a third preferred variant of preparing the powder slurries of the invention, a liquid melt of the constituents described above together with the unmelted effect pigments is introduced into an emulsifying apparatus, preferably with the addition of water and stabilizers, and the emulsion obtained is cooled and filtered, giving the powder slurry of the invention. In order to achieve a high quality of mixing, it is essential to carry out mixing in the melt without solvent. Accordingly, the polymeric constituents are fed into the dispersing apparatus in the form of viscous resin melts.

The powder coating materials and powder slurries of the invention serve to produce the inventive basecoats of the multicoat effect coating systems of the invention on a substrate.

The multicoat effect coating system of the invention is used in particular in automotive finishing, in the interior and exterior coating of constructions, in the coating of furniture, doors and windows, and in industrial coating, including coil coating and container coating, suitable substrates being all those customary and known substrates in these technical fields, being made of metal, plastic, glass, wood, textile, leather, natural stone, artificial stone, concrete, cement, or composites of these materials, preference being given to the electrically conductive substrates.

The multicoat effect coating system of the invention is preferably preparable on a substrate by

(1) applying a surfacer to a cathodically deposited and thermally cured electrodeposition coat or wet-on-wet to a cathodically deposited, uncured or only part-cured electrodeposition coating film, and then

(2) curing the resultant surfacer film, on its own, thermally, or thermally and with actinic radiation, or curing it together with the electrodeposition coating film, thermally, or thermally and with actinic radiation, to give the surfacer coat or antistonechip primer,

(3) applying the powder coating material or powder slurry of the invention to the surfacer coat or antistonechip primer, to give a powder coating film or powder slurry film,

(4) flashing off or drying the powder coating film or powder slurry film without crosslinking it completely, or—alternatively—curing it physically or thermally and/or with actinic radiation, to give the basecoat,

(5) applying at least one clearcoat material to the powder coating film or powder slurry film or—alternatively—to the basecoat, and then

(6) curing the powder coating film or powder slurry film and the clearcoat film(s) together, thermally, or thermally and with actinic radiation, or—alternatively—curing the clearcoat film on its own thermally and/or with actinic radiation, to give the basecoat and the clearcoat.

Examples of suitable cathodic electrodeposition coating materials and also, where appropriate, of wet-on-wet processes are described in Japanese Patent Application 1975-142501 (Japanese Laid-Open Specification JP 52-065534 A2, Chemical Abstracts No. 87: 137427) or in the U.S. Pat. Nos. 4,375,498 A1, 4,537,926 A1, 4,761,212 A1, EP 0 529 335 A1, DE 41 25 459 A1, EP 0 595 186 A1, EP 0 074 634 A1, EP 0 505 445 A1, DE 42 35 778 A1, EP 0 646 420 A1, EP 0 639 660 A1, EP 0 817 648 A1, DE 195 12 017 C1, EP 0 192 113 A2, DE 41 26 476 A1 or WO 98/07794.

Examples of suitable surfacers, especially aqueous surfacers, which are also known as antistonechip primers or functional coats, are described in U.S. Pat. No. 4,537,926 A1, EP 0 529 335 A1, EP 0 595 186 A1, EP 0 639 660 A1, DE 44 38 504 A1, DE 43 37 961 A1, WO 89/10387, U.S. Pat. Nos. 4,450,200 A1, 4,614,683 A1 or WO 490/26827.

Suitable clearcoats are all customary and known clearcoats.

Examples of suitable clearcoats are the following:

thermally curable one-component (1K), two-component (2K) or multicomponent (3K, 4K) clearcoats, as described in German Patent Application DE 42 04 518 A1, in European Patent Applications EP 0 594 068 A1, 0 594 071 A1, 0 594 142 A1, 0 604 992 A1 or 0 596 460 A1, in the International Patent Applications WO 94/10211, WO 94/10212, WO 94/10213, WO 94/22969 or WO 92/22615, or in U.S. Pat. Nos. 5,474,811 A1, 5,356,669 A1 or 5,605,965 A1;

thermally curable powder clearcoats, as disclosed, for example, in German Patent Application DE 42 22 194 A1 or in the product information bulletin from BASF Lacke+Farben AG, “Pulverlacke”, 1990;

powder slurry clearcoats curable thermally and/or with actinic radiation, as are described, for example, in U.S. Pat. Nos. 4,268,542 A1 or 5,379,947 A1 and in patent applications DE 27 10 421 A1, DE 195 40 977 A1, DE 195 18 392 A1, DE 196 17 086 A1, DE 196 13 547 A1, DE 196 18 657 A1, DE 196 52 813 A1, DE 196 17 086 A1, DE 198 14 471 A1, DE 198 41 842 A1 or DE 198 41 408 A1, or in German Patent Applications DE 199 08 018.6 or DE 199 08 013.5, unpublished at the priority date of the present specification; or

UV-curable clearcoats and powder clearcoats, as disclosed, for example, in European Patent Applications EP 0 928 800 A1, 0 636 669 A1, 0 410 242 A1, 0 783 534 A1, 0 650 978 A1, 0 650 979 A1, 0 650 985 A1, 0 540 884 A1, 0 568 967 A1, 0 054 505 A1 or 0 002 866 A1, in German Patent Applications DE 197 09 467 A1, 42 03 278 A1, 33 16 593 A1, 38 36 370 A1, 24 36 186 A1 or 20 03 579 B1, in International Patent Applications WO 97/46549 or 99/14254, or in U.S. Pat. Nos. 5,824,373 A1, 4,675,234 A1, 4,634,602 A1, 4,424,252 A1, 4,208,313 A1, 4,163,810 A1, 4,129,488 A1, 4,064,161 A1 or 3,974,303 A1. Also known are powder coating materials which can be crosslinked thermally and with actinic radiation (cf. European Patent Application EP 0 844 286 A).

The resulting clearcoats may further be coated with a scratchproof coating of an organically modified ceramic material, as on the market under the brand name ORMOCER®, for example.

In general, the coating materials for use in accordance with the invention are applied in a wet film thickness such that curing thereof results in coatings having the coat thicknesses advantageous and necessary for their functions. In the case of the electrodeposition coat these thicknesses are from 5 to 40, preferably from 10 to 35, with particular preference from 12 to 30, and, in particular, from 15 to 25 μm; in the case of the surfacer coat, antistonechip primer or functional coat they are from 10 to 60, preferably from 12 to 55, with particular preference from 15 to 50, and, in particular, from 18 to 45 μm; in the case of a basecoat they are from 5 to 50, preferably from 5 to 40, with particular preference from 5 to 30, and, in particular, from 10 to 25 μm; and in the case of a clearcoat they are from 10 to 100, preferably from 15 to 80, with particular preference from 20 to 75, and, in particular, from 25 to 70 μm. However, in the multicoat system of the invention the functional coat may have a thickness of only from 20 to 50% of the overall coat thickness of functional coat and basecoat.

Furthermore, the powder slurries of the invention also serve to produce the combination effect coats of the invention.

In the context of the present invention, combination effect coats are coats which in a multicoat effect coating system fulfill at least two functions. Functions of this kind are, in particular, corrosion protection, adhesion promotion, the absorption of mechanical energy, and the provision of effect. In accordance with the invention, the combination effect coat serves in particular to absorb mechanical energy and to provide effect at the same time; it therefore fulfills the functions of a surfacer coat or antistonechip primer and of a basecoat. Furthermore, the combination effect coat preferably has a corrosion protection and/or adhesion promotion activity as well.

Within a given multicoat effect coating system of the invention, the thickness of the combination effect coat is preferably constant. In some cases, however, it may be advisable to save on material by reducing the thickness of the coat in those regions of the substrate which are less subject to mechanical attack and/or are substantially or completely hidden.

Of course, the thickness of the combination effect coat may vary very widely from one multicoat effect coating system of the invention to another. In this context, the optimum thickness for each specific case is guided in particular by the hiding power of the pigments used (cf. Römpp Lexikon Lacke und Druckfarben, Georg Thieme Verlag, Stuttgart, New York, 1998, page 124, “Hiding power”), by the ability to absorb or dissipate mechanical energy, by the ability to compensate for unevennesses in the substrate surface, and/or by other constituents employed respectively in the powder slurry. The skilled worker will therefore be able to determine the optimum thickness on the basis of his or her general knowledge in the art, with the aid if required of simple preliminary rangefinding tests. The thickness of the combination effect coat is preferably from 10 to 100, more preferably from 15 to 90, with particular preference from 20 to 80, with very particular preference from 25 to 70, and, in particular, from 30 to 60 μm, based in each case on the coat.

To produce the combination effect coat that is essential to the invention, the above-described powder slurries of the invention are applied to the above-described primed and unprimed substrates by the process of the invention.

Although the powder slurries of the invention are also suitable for use outside of the coating of motor vehicle bodies, its principal industrial end use lies within said sector since it is here that its special advantages are manifested quite obviously. The substrates are therefore motor vehicle bodies, especially automobile bodies, and also parts thereof, such as doors, engine hoods, wings, trunk lid spoilers, sills or wind deflectors.

These bodies and parts consist in particular of steel or aluminum. The metal surfaces may in this case carry primers. In the case of aluminum, for example, there may be an oxide layer produced by anodic oxidation (Eloxal® process). In the case of steel, there is normally a thermally cured cathodic electrodeposition coating. However, it is also possible to use a cathodic electrodeposition coat which has not been thermally cured but is merely dried or partially cured.

The electrodeposition coat or coating is then overcoated with the powder slurry of the invention, which is either cured on its own or together with the electrodeposition coat (wet-on-wet process).

The resultant combination effect coat of the invention may be coated with at least one additional coat. Preferably, the additional coat concerned comprises at least one of the above-described clearcoats. This results in particularly advantageous multicoat effect coating systems of the invention having an outstanding overall visual appearance and a particularly high scratch resistance.

When the combination effect coat is coated with a clearcoat, the cured combination effect coat may be overcoated with at least one clearcoat, which is then cured on its own.

In a second variant, which is preferred in accordance with the invention, the uncured, or only partially cured, pigmented powder slurry coat may be overcoated directly with at least one clearcoat, after which the clearcoat film(s) is (are) cured together with the pigmented powder slurry film and, if appropriate, the electrodeposition coating film (wet-on-wet process).

The powder slurries of the invention can be applied using the methods known from liquid coating technology. In particular, they can be applied by means of spraying processes. Preferably, they are applied by electrostatic painting of the exterior body parts followed by pneumatic spraying (compressed-air spraying) of the interior body parts.

The electrostatic painting can take place by means of an electrostatic spraying gap, an electro-static spraying bell, or an electrostatic spraying disk.

Furthermore, the electrostatic painting may take place by means of electrostatically assisted mechanical atomization. Preferably, this is carried out with the aid of electrostatic high-speed rotary disks or high-speed rotary bells.

The pneumatic spraying or compressed-air painting, as well, has no special features as to its method, but can be carried out by hand or using customary and known automatic painting equipment or paint robots.

For further details, reference is made here to Römpp Lexikon Lacke und Druckfarben, Georg Thieme Verlag, Stuttgart, New York, 1998, page 186: “Electrostatic coating”, page 187:“Electrostatic spray guns”, “Electrostatic Spraying”, and page 165: “Compressed-air spraying”.

Preferably, application is carried out under illumination with visible light having a wavelength of more than 550 μm or in the absence of light if the pigmented powder slurries are curable thermally and with actinic radiation. By this means, material alteration or damage to the coating material to be used in accordance with the invention and to the overspray is avoided.

Of course, these application processes can also be employed for the application of additional coats, preferably clearcoats, provided the coating material concerned is not a powder coating material, especially a powder clearcoat and/or the powder coating material of the invention, which is preferably processed in accordance with the processes described in the product information bulletin from BASF Lacke+Farben AG, “Pulverlacke”, 1990 or the BASF Coatings AG brochure “Pulverlacke, Pulverlacke für industrielle Anwendungen”, January 2000.

The method of curing the applied electrodeposition coating films, surfacer films, basecoat films, combination effect films and clearcoat films has no special features but instead takes place with the aid of the customary and known processes and apparatus.

In the case of physical curing it is not really necessary to take any specific measures; the physical curing can, however, be assisted by atmospheric oxygen, by heat or by exposure to actinic radiation.

Thermal curing may be carried out after a certain resting time or flash-off time. It may last for from 30 seconds to 2 hours, preferably from 1 minute to 1 hour, and in particular from 1 minute to 45 minutes. The resting time is used, for example, for leveling and degassing of the coats and for the evaporation of volatile constituents such as any solvents and/or water that may still be present. Flashing off can be accelerated by an elevated temperature though still below that for curing, and/or by reduced atmospheric humidity.

The thermal curing takes place for example by heating in a convection oven or irradiation with IR and/or NIR lamps. As in the case of curing with actinic radiation, the thermal curing may also take place in stages. Advantageously, thermal curing takes place at temperatures from 100 to 180° C.

In the case of curing with actinic radiation, it is preferred to employ a dose of from 1000 to 3000, preferably from 1100 to 2900, with particular preference from 1200 to 2800, with very particular preference from 1300 to 2700, and in particular from 1400 to 2600 mJ/cm². If desired, this curing may be supplemented by actinic radiation from other radiation sources. In the case of electron beams, it is preferred to operate under an inert gas atmosphere. This can be ensured, for example, by supplying carbon dioxide and/or nitrogen directly to the surface of the powder slurry coat. In the case of curing with UV radiation as well, it is possible to operate under inert gas in order to prevent the formation of ozone.

Curing with actinic radiation is carried out using the customary and known radiation sources and optical auxiliary measures. Examples of suitable radiation sources are flashlights from the company VISIT, high-pressure or low-pressure mercury vapor lamps, with or without lead doping in order to open a radiation window of up to 405 nm, or electron beam sources. The arrangement of these sources is known in principle and may be adapted to the circumstances of the workpiece and the process parameters. In the case of workpieces of complex shape, as provided for automobile bodies, those regions not accessible to direct radiation (shadow regions), such as cavities, folds and other structural undercuts, may be (partially) cured using point, small-area or all-round emitters, in combination with an automatic movement apparatus for the irradiation of cavities or edges.

The equipment and conditions for these curing methods are described, for example, in R. Holmes, U. V. and E. B. Curing Formulations for Printing Inks, Coatings and Paints, SITA Technology, Academic Press, London, United Kingdom 1984.

Full curing here may take place in stages, i.e., by multiple exposure to light or actinic radiation. It can also take place in alternation; in other words, by curing alternately with UV radiation and electron beams.

In the case of dual cure, thermal curing and curing with actinic radiation can be employed simultaneously or in succession. If the two curing methods are used in succession, it is possible, for example, to commence with thermal curing and end with curing with actinic radiation. In other cases, it may prove advantageous to commence and to end with curing with actinic radiation.

Overall, the processes of the invention for producing the multicoat effect coating systems of the invention offer the extremely environmentally and economically advantageous and significant possibility not only of producing coating systems on a purely aqueous basis without emission of volatile organic substances, but of doing so with a reduced number of coats. If the corresponding solvent-free clearcoats are employed, this also applies to the multicoat effect coating systems of the invention which comprise at least one clearcoat.

The multicoat effect coating systems of the invention obtained in the manner of the invention are distinguished by very good substrate adhesion, very good intercoat adhesion, outstanding corrosion protection, very good protection against stone chipping and other mechanical damage, very good leveling, and a very good overall visual appearance, especially as regards depth of color, metallic effect, dichroic effect and D.O.I. (distinctness of the reflected image).

The bodies of the invention coated accordingly therefore impart a particularly high overall aesthetic impression and have a particularly long service life.

### EXAMPLES

### Example 1

The Production of a Multicoat Effect Coating System of the Invention Using a Powder Slurry of the Invention

For Example 1, a powder coating material was first prepared, as described in German Patent Application DE 196 13 547 A1, from 77.4 parts by weight of a methacrylate copolymer formed from methyl methacrylate, glycidyl methacrylate, n-butyl acrylate and styrene, 19.4 parts by weight of dodecanedioic acid, 2 parts by weight of a commercial UV absorber (Ciba® CGL 1545), 1 part by weight of the commercial light stabilizer Tinuvin® 123, and 0.25 part by weight of the commercial antioxidant Irgafos® PEPQ.

This powder coating material was dispersed in water in accordance with the experimental procedure specified in German Patent Application DE 196 18 657 A1, column 6, to give a pigmented powder slurry.

Table 1 gives an overview of the nature and amount of the constituents used in this case.

TABLE 1
The preparation of the powder slurry of the invention

| | Parts by weight |
|---|---|
| Constituent | Example 1 |
| Predispersion: | |
| DI water^{a)} | 42 |
| Disperse Aid W22^{b)} | 1.03 |
| Triton X100^{c)} | 0.02 |
| Dimethylethanolamine | 0.08 |
| RM 8^{d)} | 0.9 |
| Powder coating material | 28 |
| Make-up: | |
| DI water^{a)} | 17.49 |
| RM 8^{d)} | 0.7 |
| Byk 333^{e)} | 0.05 |
| Triton X100^{c)} | 0.18 |
| Effect pigment^{f)} | 5.0 |

^{a)}deionized water;
^{b)}polurethane-based dispersant from Daniel Products;
^{c)}defoamer from Union Carbide;
^{d)}polyurethane-based thickener from Rohm & Haas;
^{e)}leveling agent from Byk Chemie;
^{f)}aluminum effect pigment from Eckhart, coated by the dry-blend process with the polypropylene glycol Pluriol ® 600 from BASF Aktiengesellschaft in a weight ratio of aluminum effect pigment: Pluriol of 99.6:0.4.

Steel panels (body panels) coated with a customary and known cathodically deposited and baked electrodeposition coating were coated manually with the powder slurry using a customary and known spray gun (pressure: 5 bar; 2 spray passes, horizontal and vertical). The wet film thickness was chosen such that baking resulted in a 40 μm coat thickness. The powder slurry coat was flashed off at 50° C. for 10 minutes and overcoated with a commercially conventional two-component clearcoat from BASF Coatings AG. The resulting clearcoat film was flashed off for 10 minutes, after which the powder slurry film and the clearcoat film were baked at 150° C. for 30 minutes. The thickness of the clearcoat was 50 μm.

The resultant coating system exhibited an outstanding hiding power. Its metallic effect and flip-flop corresponded entirely to those of a correspondingly pigmented basecoat. The adhesion to the primer, and the intercoat adhesion, and also the antistonechip effect, were very good even after weathering under constant humid climate conditions. Defects in leveling, popping, cracking (mud-cracking), or surface structures such as orange peel were not observed.

### Example 2

The Production of a Multicoat Effect Coating System of the Invention Using a Powder Coating Material of the Invention

For Example 2, the powder coating material was prepared in accordance with Example 1 except that 5.5 parts by weight of the coated aluminum effect pigment from Table 1 were added.

For this purpose, the constituents of the powder coating material as listed in Example 1 and the coated aluminum effect pigment were weighed out. The batch size was 5.0 kg. The constituents were homogenized in a Henschel fluid mixer at 2800 rpm for two minutes. After premixing by means of a hopper, the resultant mixture was supplied to an extruder (BUSS PR 46). The extruder was started up in each case with a barrel temperature of 110° C. and the rotational speed was chosen so that the barrel temperature was maintained at 60° C. The emerging extrudate was cooled to 20° C. with a chill roll and chipped using a crusher. The chips were precut and then ground in a pin mill. The resultant powder was sieved off above 125 μm using a tumble sieve.

The powder coating material of Example 2 was applied using a manual laboratory gun with Corona charging, of type Wagner ESB, in a film thickness of from 40 to 50 μm to steel panels which had been coated with a customary and known, cathodically deposited and baked electrodeposition coat and with a customary and known antistonechip primer. The resultant powder coating films were baked at 160-180° C. for 10-25 minutes.

The basecoat obtained in this way was overcoated with a commercially customary two-component clearcoat, the resultant clearcoat film being cured at 60° C.

The multicoat effect coating system exhibited very good leveling and a very good overall visual impression. In total, the same advantages were obtained as with the multicoat effect coating system of Example 1.

What is claimed is:

1. A powder coating material or powder coating dispersion (powder slurry) comprising at least one hydrophilic effect pigment.

2. The coating material or slurry as claimed in claim 1, characterized in that it comprises as effect pigment a metal effect pigment.

3. The coating material or slurry as claimed in claim 2, characterized in that it comprises as metal effect pigment an aluminum pigment.

4. The coating material or slurry as claimed in any of claims 1 to 3, characterized in that the effect pigments are coated with at least one surface-active substance.

5. The coating material or slurry as claimed in claim 4, characterized in that the surface-active substances used comprise surfactants.

6. The coating material or slurry as claimed in claim 5, characterized in that the surfactants used comprise nonionic surfactants.

7. The coating material or slurry as claimed in claim 6, characterized in that the nonionic surfactants used comprise polyalkylene glycols.

8. The coating material or slurry as claimed in claim 7, characterized in that the polyalkylene glycols used comprise polypropopylene glycols.

9. The coating material or slurry as claimed in claim 8, characterized in that the number-average molecular weight of the polypropopylene glycol is from 350 to 1000 daltons.

10. The coating material or slurry as claimed in any of claims 1 to 9, characterized in that it is curable physically or thermally and/or with actinic radiation.

11. The coating material or slurry as claimed in any of claims 1 to 10, characterized in that it is free from organic solvents.

12. The coating material or slurry as claimed in any of claims 1 to 11, characterized in that the totality of the coated effect pigments is present in the powder coating particles, as a separate solid phase, or partly in the powder coating particles and partly as a separate solid phase.

13. The slurry as claimed in any of claims 1 to 12, characterized in that it is pseudoplastic.

14. The use of a powder coating material as claimed in any of claims 1 to 12 or of a powder slurry as claimed in any of claims 1 to 13 to produce basecoats or combination effect coats in multicoat effect coating systems.

15. A multicoat effect coating system comprising a combination effect coat, preparable by applying a powder slurry as claimed in any of claims 1 to 13 to a cathodically deposited and thermally cured electrodeposition coat or wet-on-wet to a cathodically deposited, uncured or only part-cured electrodeposition coating film, and then curing the resultant powder slurry film, on its own, physically or thermally and/or with actinic radiation, or curing it together with the electrodeposition coating film, thermally or thermally and with actinic radiation, to give the combination effect coat.

16. The multicoat effect coating system as claimed in claim 15, characterized in that either the powder slurry film or the combination effect coat is overcoated with at least one clearcoat material, after which the resulting clearcoat film is cured
(1) on its own, thermally and/or with actinic radiation,
(2) together with the powder slurry film, thermally and/or with actinic radiation, or
(3) together with the electrodeposition coating film and the powder slurry film, thermally or thermally and with actinic radiation.

17. A multicoat effect coating system comprising a basecoat, preparable by
(1) applying a surfacer to a cathodically deposited and thermally cured electrodeposition coat or wet-on-wet to a cathodically deposited, uncured or only part-cured electrodeposition coating film, and then
(2) curing the resultant surfacer film, on its own, thermally, or thermally and with actinic radiation, or curing it together with the electrodeposition coating film, thermally, or thermally and with actinic radiation, to give the surfacer coat or antistonechip primer,
(3) applying a powder coating material or powder slurry to the surfacer coat or antistonechip primer, to give a powder coating film or powder slurry film,
(4) flashing off or drying the powder coating film or powder slurry film without crosslinking it completely, or—alternatively—curing it physically or thermally and/or with actinic radiation, to give the basecoat,
(5) applying at least one clearcoat material to the powder coating film or powder slurry film or—alternatively—to the basecoat, and then
(6) curing the powder coating film or powder slurry film and the clearcoat film(s) together, thermally and/or with actinic radiation, or—alternatively —curing the clearcoat film on its own thermally and/or with actinic radiation, to give the basecoat and the clearcoat,
characterized in that a powder coating material as claimed in any of claims 1 to 12 or a powder slurry as claimed in any of claims 1 to 13 is used.
